(19) United States
(12) Patent Application Publication
(10) Pub. No.: US 2003/0033153 A1
(43) Pub. Date: Feb. 13, 2003

(54) Microphone elements for a computing system

(75) Inventors: Robert N. Olson, Mountain View, CA (US); Lawrence F. Heyl, Champaign, IL (US); Noah M. Price, Campbell, CA (US); Kim E. Silverman, Mountain View, CA (US)

Correspondence Address: BEYER WEAVER & THOMAS LLP, P.O. BOX 778, BERKELEY, CA, 94704-0778, US

(73) Assignee: Apple Computer, Inc.

(21) Appl. No.: 10/206,130

(22) Filed: Jul. 25, 2002

Related U.S. Application Data
(60) Provisional application No. 60/311,070, filed on Aug. 8, 2001.

(51) Int. Cl. G10L 21/00

(52) U.S. Cl. 704/275

(57) ABSTRACT

An improved speech recognition device is provided. The speech recognition device comprises a display with at least two built in microphones and a speech recognition module electrically connected to the display. The speech recognition module uses an algorithm that may take into account the position of the built in microphone on the display. The display may have a first axis of rotation where the microphones may be placed an equal distance from the first axis of rotation.

### RELATED APPLICATIONS

This application claims priority under 35 U.S.C. 119(e) of the U.S. provisional application entitled “Microphone Elements for a Computing System”, filed Aug. 8, 2001, by inventors Robert N. Olson, Lawrence F. Heyl, Noah M. Price, and Kim E. Silverman, U.S. Provisional Application No. 60/311,070, which is incorporated by reference.

### FIELD OF THE INVENTION

The present invention relates generally to computer systems. More particularly, the present invention relates to speech processing for computer systems.

### BACKGROUND OF THE INVENTION

Computer systems, such as speech recognition systems use a microphone to capture sound.

To facilitate discussion, FIG. 1 is a bird's eye view of a top view of a computer system being used for speech recognition. A computer 100 has a microphone 104, which is used for speech recognition. A user 108 may sit directly in from on the microphone 104 to provide oral commands 112, which may be recognized by the computer. The oral commands 112 are picked up by the microphone 104 to generate a signal, which is interpreted as a command. Background noise may be caused by a non-user 116 speaking 120 or making other noise or by other objects making noise or by echoes 124 of the oral commands. Speech recognition software in the computer 100 currently tries to screen out background noise. If the computer 100 does not successfully do this, the noise from the echo 124 or the non-user 116 or other noise may be interpreted as a command causing the computer 100 to perform an undesired action. One way this is done in the prior art is to have the computer continuously monitor the spectral characteristics of the microphone and the background noise and to use these measurements to adjust the computer to the background noise so that background noise may be more easily screened. In addition the computer 100 may measure and normalize the user's speech spectral characteristics so that the computer looks for a signal with the measure user speech spectral characteristics. One of the difficulties with the approach is if the user changes speech spectral characteristics, such as by turning away from the microphone or changing the distance to the microphone, the computer 100 may not recognize commands from the user 108 until the computer 100 has reset the user's spectral characteristics.

It would be desirable to provide a computer system with speech recognition, which is better able to distinguish user commands from background noise.

### SUMMARY OF THE INVENTION

To achieve the foregoing and other objects and in accordance with the purpose of the present invention, a variety of techniques is provided for a speech recognition device is provided comprising a display with at least two built in microphones and a speech recognition module electrically connected to the display. The speech recognition module uses an algorithm that may take into account the position of the built in microphone on the display.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a bird's eye view of a top view of a computer system being used for speech recognition.

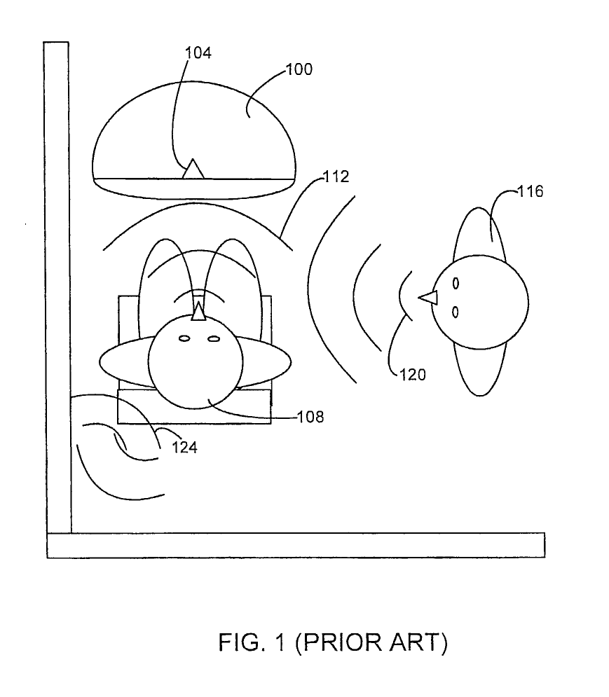

FIG. 2 is a high level view of a computer system, which may be used in an embodiment of the invention.

FIG. 3 is a high level flow chart for the working of the computer system.

FIG. 4 is a more detailed schematic view of the sound recognition front end.

FIG. 5 is a more detailed flow chart of the step of having the front end select acoustic models.

FIGS. 6A and 6B illustrate a computer system, which is suitable for implementing embodiments of the present invention.

FIG. 7 illustrates a computer system, comprising a display, two microphones, and a chassis utilized in another embodiment of the invention.

FIG. 8 illustrates a computer system, comprising a display, four microphones, and a chassis utilized in another embodiment of the invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not unnecessarily obscure the present invention.

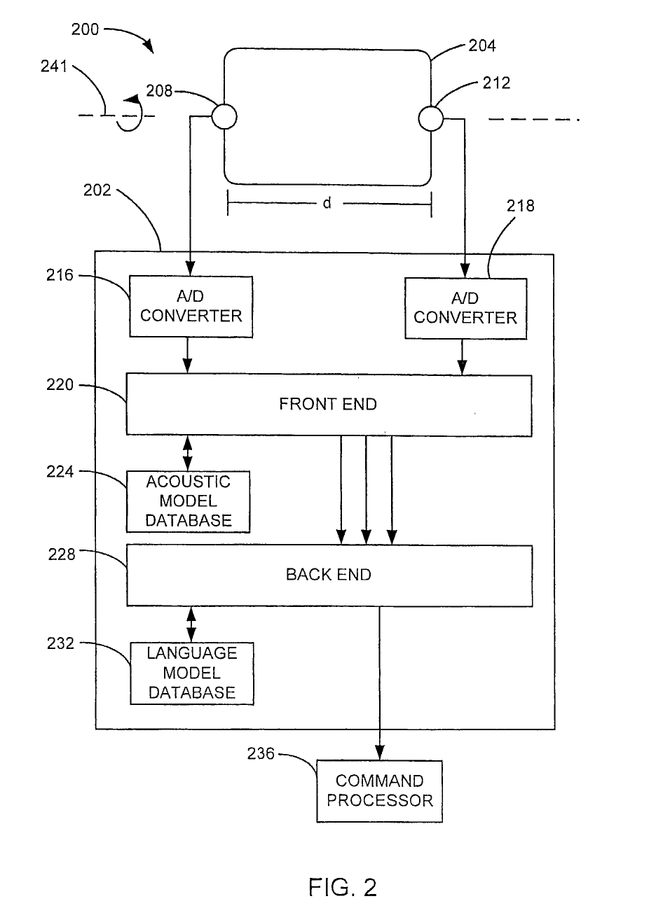

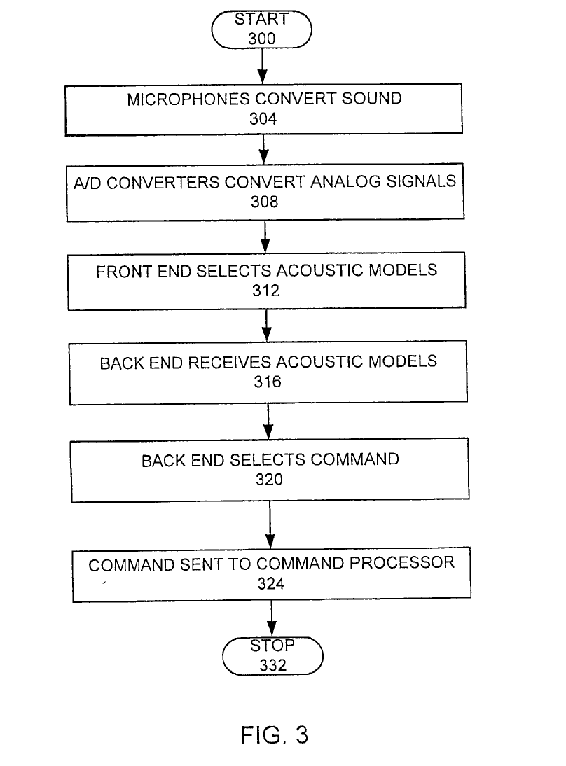

To facilitate discussion, FIG. 2 is a high level view of a computer system 200 with speech recognition module 202 and a display 204 with a built in first microphone 208 and a built in second microphone 212, which may be used in an embodiment of the invention. FIG. 3 is a high level flow chart for the working of the computer system 200. The first microphone 208 and second microphone 212 receive sound and convert the sound to an electrical signal (step 304). The first microphone 208 feeds an electrical signal to a first analog to digital converter 216, and the second microphone 212 feeds an electrical signal to a second analog to digital converter 218. The first and second analog to digital converters 216, 218 convert an analog signals to digital signals (step 308). The digital signals provide a voltage amplitude according at set time intervals according to the voltage amplitude of the analog signal at the set time intervals. The digital signals from the first and second analog to digital converters 216, 218 are fed to a speech recognition front end 220. The front end 220 processes the digital signals and selects a plurality of acoustic model hypotheses from an acoustic model database 224 that most closely match the digital signals (step 312). The acoustic model hypotheses are phonemes, which are consonance and vowel sounds used by a language, which the front end 220 selects as the closest match between the spectral model of phoneme and the spectral model of the speech, which generates the digital signals. The selected plurality of acoustic models are sent from the front end to the back end 228 (step 316). The back end 228 compares the selected plurality of acoustic models with a language model, which is a model of what can be spoken, in a language model database 232, and determines a command (step 320). The determined command is sent to a command processor 236 (step 324). The speech recognition module 202 may be an API.

Although drawn separately, the front end 220 and back end 228 may be integrated together and may act simultaneously, with the front end 220 continuously generating many hypotheses of what the computer thinks may be the phonemes from the captured speech and the back end 228 continuously eliminating hypotheses from the front end according to what is can be said until a single hypotheses remains, which is then designated as the command. The command may represent any type of input such as an interrupt or text input.

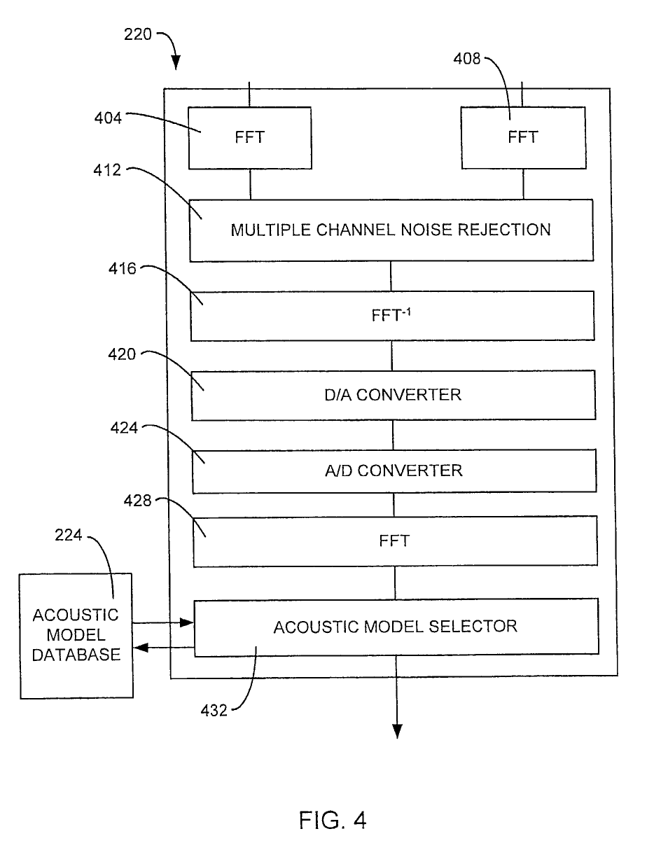

FIG. 4 is a more detailed schematic view of the sound recognition front end 220. The front end 220 comprises a first Fast Fourier Transform device 404, which receives input from the first analog to digital converter 216 and a second Fast Fourier Transform device 408, which receives input from the second analog to digital converter 218. The output from the first Fast Fourier Transform device 404 and the second Fast Fourier Transform device 408 is connected to an input of a multiple channel noise rejection device 412. The output of the multiple channel noise rejection device 412 is connected to an inverse Fast Fourier Transform device 416. The output of the inverse Fast Fourier Transform device 416 is connected to an input of a digital to analog converter 420. The output of the digital to analog converter 420 is provided as input to an analog to digital converter 424. The output of the analog to digital converter 424 is provided as input to a third Fast Fourier Transform device 428. The output of the third Fast Fourier Transform device 428 is provided as input to an acoustic model selector 432. The acoustic model selector 432 is in two way communications with the acoustic model database 224. The output of the acoustic model selector 432 is connected to the backend 228.

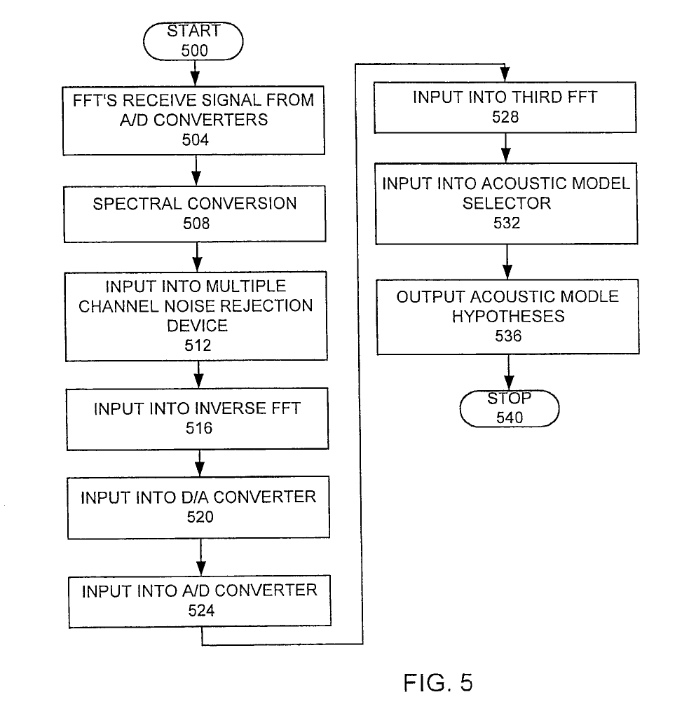

FIG. 5 is a more detailed flow chart of the step of having the front end select acoustic models (step 312) that illustrates the operation of the front end 220. The first and second Fast Fourier Transform devices 404, 408 receive signals from the first and second analog to digital converters 216, 218 (step 504). The first and second Fast Fourier Transform devices 404, 408 provide a spectral conversion of the digital signals from the first and second analog to digital converters 216, 218 from the time domain signals to a frequency domain signal (step 508). Other frequency based spectral conversions may be used in place of fast Fourier analysis, such as linear predictive analysis. The converted signals from the first and second Fast Fourier Transform devices 404, 408 are fed to the multiple channel noise rejection device 412 (step 512). The multiple channel noise rejection device 412 uses a noise rejection process, such as beam forming, which is used to improve the signal to noise ratio, or off axis rejection, which is us to eliminate undesirable signals. Such noise rejection methods are known in the art.. The output of the multiple channel noise rejection device 412 is then fed into the inverse Fast Fourier Transform device 416, which converts the output from the frequency domain to the time domain (step 516). The output of the inverse Fast Fourier Transform device 416 is input into the digital to analog converter 420, which converts the digital signal to an analog signal (step 520). The output of the digital to analog converter 420 is input into the analog to digital converter 424 (step 524), which converts the analog signal to a digital signal. The output of the analog to digital converter 424 is input to the third Fast Fourier Transform device 428, which converts the output of the analog to digital converter 420 from the time domain to the frequency domain (step 528). The output from the third Fast Fourier Transform device 428 is input to the acoustic model selector 432 (step 532). The acoustic model selector 432 compares the input from the third Fast Fourier Transform device 428 with acoustic models in the model database 224 to provide a plurality of acoustic model hypotheses as output (step 536).

For such a system to effectively use two or more microphones to provide multiple channel noise rejection, it is desirable to locate the microphones at specifically chosen locations. For the computer system shown in FIG. 2, the display 204 is built to rotate around a display axis 241. In this embodiment of the invention, the microphones are set on each side of the display 204 on the display axis 241 and are separated from each other a known distance “d”, which in this example is the width of the display 204. For a user directly in front of the display 204, the distance from the first microphone 208 to the user should be about equal to the distance from the second microphone 212 to the user. The multiple channel noise rejection device 412 would be able to use the equal distance between the user and the first and second microphones 208, 212 to suppress background noise.

It has been found that if the display is rotated around the display axis 241 placement of the first microphone 208 and the second microphone 212 on the display axis 241 on opposite sides of the display, that better noise suppression may be obtained. If both of the microphones were instead placed at the top of the display 241, then tilting the display upward would cause a greater lowering of the signal to noise ratio than when the microphones are placed on the display axis 241.

By integrating the first and second microphones 208, 212 with the display 204 the microphones may be placed at locations that are dependent upon features of the display allowing for improved noise suppression.

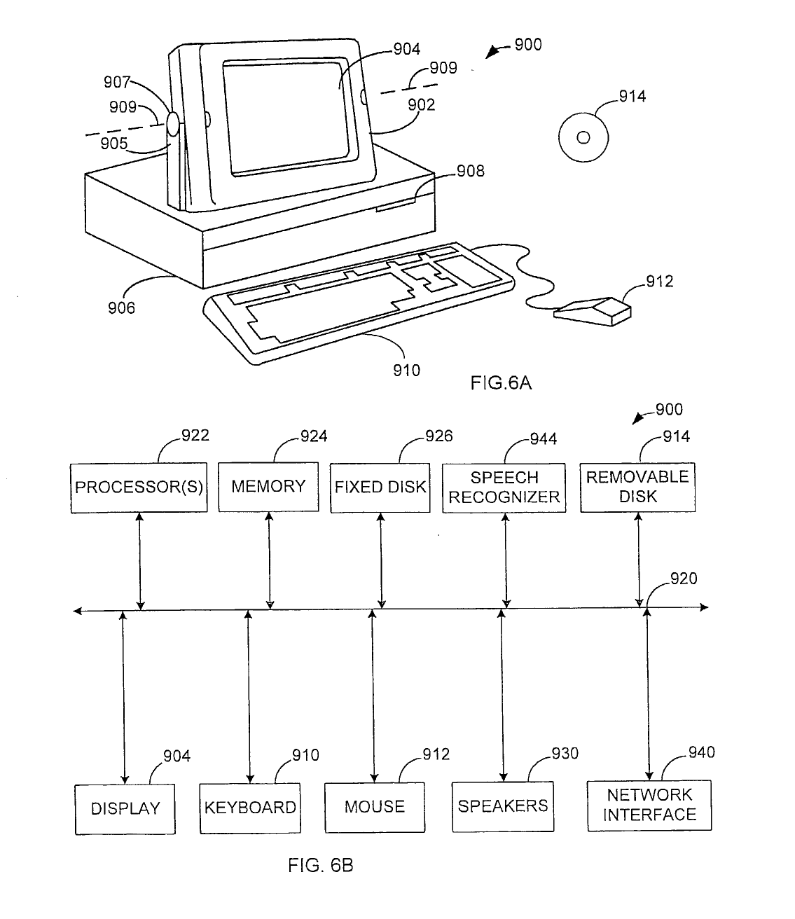

FIGS. 6A and 6B illustrate a computer system, which is suitable for implementing embodiments of the present invention. FIG. 6A shows one possible physical form of the computer system. Of course, the computer system may have many physical forms ranging from an integrated circuit, a printed circuit board, and a small handheld device up to a desktop personal computer. Computer system 900 includes a monitor 902, a display 904, a chassis 906, a disk drive 908, a keyboard 910, and a mouse 912. Disk 914 is a computer-readable medium used to transfer data to and from computer system 900. So that the computer system 900 may be an example of the computer system illustrated in FIG. 2, a stand 905 is provided. A hinge 907 allows the monitor 902 to be mounted to the stand 905, so that the monitor may be able to rotate around a display axis 909. A first microphone 911 and a second microphone 913 are set on each side of the monitor 902 on the display axis 909.

FIG. 6B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data, and the like and is typically a secondary storage medium (such as a hard disk) that is slower than primary storage. It will be appreciated that the information retained within fixed disk 926, may, in appropriate cases, be incorporated in standard fashion as virtual memory in memory 924. Removable disk 914 may take the form of any of the computer-readable media described below. A speech recognizer 944 is also attached to the system bus 920. The speech recognizer 944 may be connected to the first microphone 907 and the second microphone 909 to form an integrated speech recognition system in which known distances between the microphones are used by the speech recognizer 944.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing. The chassis 906 may be used to house the fixed disk 926, memory 924, network interface 940, and processors 922.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

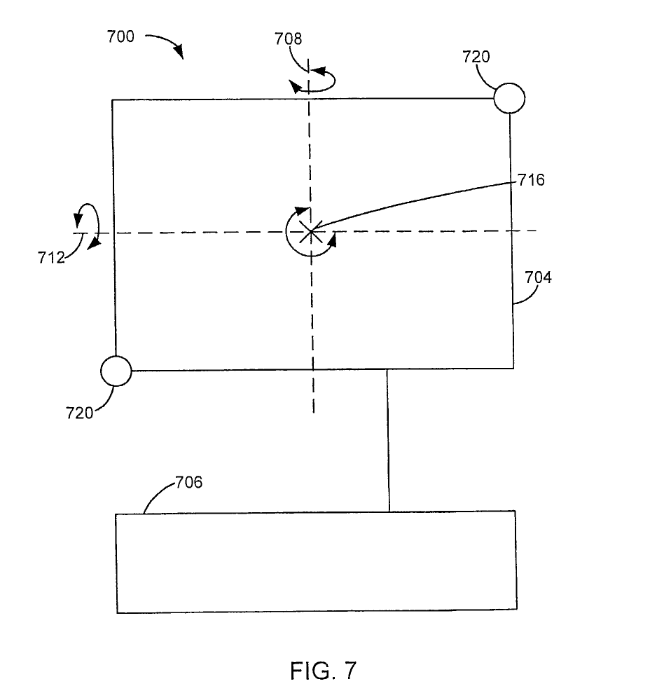

FIG. 7 illustrates a computer system 700, comprising a display 704, two microphones 720, and a chassis 706 utilized in another embodiment of the invention. In this embodiment, a first axis of rotation 708, a second axis of rotation 712, and a third axis of rotation 716 for the display are indicated. The two microphones 720 are mounted on opposite comers of the rectangular display 704. The first axis of rotation 708 provides a right and left rotation of the display 704 as shown by the arrow around the first axis of rotation 708. The second axis of rotation 712 provides an up and down rotation of the display as shown by the arrow around the second axis of rotation 712. The third axis of rotation 716 allows the display 704 to be spun around as indicated by the arrow around the third axis of rotation 716. It has been found that placement of the microphones on opposite corners provides greater noise suppression for displays that have axes of rotations around the first and the second axes of rotation 712, or around the third axis of rotation 716, or around the first, second, and third axes of rotation 708, 712, 716. The chassis 706 may contain a speech recognition module, such as the speech recognition module 202 described above, a processor and computer storage. The software to provide beam forming for the speech recognition module would be written to use an algorithm to account for the positioning of the microphones 720 with respect to the axes of rotation. The integration of the display 700, microphones 720, and chassis 706 into a computer system designed as an integrated system allows for the use of beam forming that takes advantage of the placement of the microphones.

In addition, microphones have different characteristics such as gain and directionality. In addition, the mounting of the microphone to the display has different characteristics such as the location of the microphones, the rigidness of the mounting, the housing around the microphone, the wire path of the microphones, and air gaps around the microphone. By building the microphones into the display noise from these characteristics may be minimized. For example, the wire path of the microphones may be placed to minimize electromagnetic interference from the display. For built in microphones, housing may be provided to reduce air currents around the microphone to minimize noise from the air currents. In addition, the algorithm used by the speech recognition module may be designed to take into account these characteristics. This can be done, because the speech recognition module is designed for the built in microphones on the display. This may be done by storing microphone characteristics, such as rigidness and location of the microphones one the computer readable media.

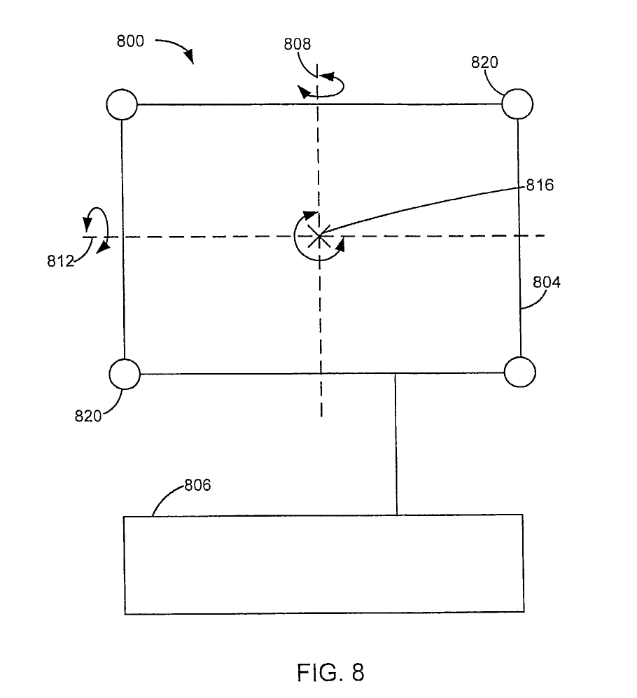

FIG. 8 illustrates a computer system 800, comprising a display 804, four microphones 820, and a chassis 806 utilized in another embodiment of the invention. In this embodiment, a first axis of rotation 808, a second axis of rotation 812, and a third axis of rotation 816 for the display are indicated. The four microphones 820 are mounted on each corner of the rectangular display 804. The first axis of rotation 808 provides a right and left rotation of the display 704 as shown by the arrow around the first axis of rotation 808. The second axis of rotation 812 provides an up and down rotation of the display as shown by the arrow around the second axis of rotation 812. The third axis of rotation 816 allows the display 804 to be spun around as indicated by the arrow around the third axis of rotation 816. It has been found that placement of the microphones on each corner provides greater noise suppression for displays that have axes of rotations around the first and the second axes of rotation 812, or around the third axis of rotation 816, or around the first, second, and third axes of rotation 808, 812, 816. In this embodiment, the four microphones 820 are directional microphones pointed towards a small volume where it is believed the mouth of the user would be. For example, it may be presumed that the user may sit from about 12 inches to about 36 inches from the display. In such a case, the microphones 320 may be directed to a point on or near the third axis of rotation 816 12 inches to 36 inches from the display. By directing directional microphones 320 towards this point and using multiple microphones with beam forming, background noise that is created outside of the vicinity where the microphones are all directed will not have as much amplification as noise created in the vicinity to which all of the microphones are directed. For instance, if sound is generated along a directional path of one microphone, but not along the directional path of the three remaining microphones, beam forming may be used to eliminate that noise.

While this invention has been described in terms of several preferred embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A speech recognition device, comprising:
a display with at least two built in microphones; and
a speech recognition module electrically connected to the display.

2. The speech recognition device, as recited in claim 1, wherein the speech recognition module uses an algorithm that takes into account the position of the built in microphone on the display.

3. The speech recognition device, as recited in claim 2, wherein the display has a first axis of rotation, wherein the at least two built in microphones are placed on the first axis of rotation.

4. The speech recognition device, as recited in claim 2, wherein the display has a first axis of rotation, wherein the at least two built in microphones are place an equal distance from the first axis of rotation.

5. The speech recognition device, as recited in claim 4, wherein the display has a second axis of rotation, wherein the at least two built in microphones are placed an equal distance from the second axis of rotation.

6. The speech recognition device, as recited in claim 5, wherein the display is rectangular, and wherein two of the at least two built in microphones are placed on opposite corners of the display.

7. The speech recognition device, as recited in claim 6, wherein the algorithm used by the speech recognition module is tailored for the gain and directionality of the at least two microphones.

8. The speech recognition device, as recited in claim 8, wherein the algorithm used by the speech recognition module is tailored for the housing and mounting of the at least two microphones.

9. The speech recognition device, as recited in claim 6, wherein the algorithm used by the speech recognition module is tailored for the housing and mounting of the at least two microphones.
